(19) United States
(12) Patent Application Publication
(10) Pub. No.: US 2012/0029939 A1
(43) Pub. Date: Feb. 2, 2012

(54) METHODS AND APPARATUS TO GROUP AND PRESENT CLINICAL RECORDS

(75) Inventors: Jason Danielson, Barrington, IL (US); Elliot Nicholas Franford, Barrington, IL (US)

(73) Assignee: GENERAL ELECTRIC COMPANY, Schenectady, NY (US)

(21) Appl. No.: 12/847,916

(22) Filed: Jul. 30, 2010

(51) Int. Cl. G06Q 50/00; G06F 17/30; G06F 3/048; G06Q 10/00

(52) U.S. Cl. 705/3; 705/2; 707/769; 715/764; 707/E17.014

(57) ABSTRACT

Methods and apparatus to present and group clinical records are disclosed. An example method includes obtaining work list data of a healthcare practitioner and one or more clinical records associated with the work list data; extracting descriptive information from the clinical records to obtain one or more classifications associated with the clinical records; organizing the clinical records using the classifications into a hierarchy associated with a multi-tiered structure for graphical display; displaying one or more work items from the work list data in a first tier of the structure associated with the hierarchy; displaying one or more nodes associated with a first one of the classifications in a second tier of the structure in response to a first selection of a first one of the work items; and presenting one or more of the clinical records in a user interface in response to a second selection from a base tier of the structure.

### FIELD OF THE DISCLOSURE

This disclosure relates generally to clinical records and, more particularly, to methods and apparatus to group and present in clinical records.

### BACKGROUND

Healthcare environments, such as hospitals and clinics, typically include information systems (e.g., hospital information systems (HIS), radiology information systems (RIS), storage systems, picture archiving and communication systems (PACS), etc.) to manage clinical information such as, for example, patient medical histories, imaging data, test results, diagnosis information, management information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Alternatively, medical personnel may enter new information, such as history, diagnostic, or treatment information, into a medical information system during an ongoing medical procedure.

Medical practitioners, such as doctors, surgeons, and other medical professionals, rely on the clinical information stored in such systems to assess the condition of a patient, to provide immediate treatment to a patient in an emergency situation, to diagnose a patient, and/or to provide any other medical treatment or attention. In many instances, the clinical information includes voluminous patient medical histories containing detailed accounts of a plurality of medical events, treatments, modalities, diagnosis, prescriptions, etc. Parsing through the medical histories is time consuming and can be inefficient.

### SUMMARY

An example computer-implemented method of grouping and presenting clinical records in a user interface includes obtaining work list data of a healthcare practitioner and one or more clinical records associated with the work list data. Further, the example method includes extracting descriptive information from the clinical records to obtain one or more classifications associated with the clinical records. Further, the example method includes organizing the clinical records using the classifications into a hierarchy associated with a multi-tiered structure for graphical display. Further, the example method includes displaying one or more work items from the work list data in a first tier of the structure associated with the hierarchy. Further, the example method includes displaying one or more nodes associated with a first one of the classifications in a second tier of the structure in response to a first selection of a first one of the work items. Further, the example method includes presenting one or more of the clinical records in the user interface in response to a second selection from a base tier of the structure.

An example tangible computer readable medium having instructions stored thereon that, when executed cause a machine to obtain work list data of a healthcare practitioner and one or more clinical records associated with the work list data. Further, the example tangible computer readable medium has instructions stored thereon that, when executed cause a machine to extract descriptive information from the clinical records to obtain one or more classifications associated with the clinical records. Further, the example tangible computer readable medium has instructions stored thereon that, when executed cause a machine to organize the clinical records using the classifications into a hierarchy associated with a multi-tiered structure for graphical display. Further, the example tangible computer readable medium has instructions stored thereon that, when executed cause a machine to display one or more work items from the work list data in a first tier of the structure associated with the hierarchy. Further, the example tangible computer readable medium has instructions stored thereon that, when executed cause a machine to display one or more nodes associated with a first one of the classifications in a second tier of the structure in response to a first selection of a first one of the work items. Further, the example tangible computer readable medium has instructions stored thereon that, when executed cause a machine to present one or more of the clinical records in the user interface in response to a second selection from a base tier of the structure.

An example work list presenter to group and present clinical records in a user interface includes a retriever to obtain work list data of a healthcare practitioner. Further, the example work list presenter includes one or more interfaces to obtain one or more clinical records associated with the work list data. Further, the example work list presenter includes an extractor to extract descriptive information from the clinical records to obtain one or more classifications associated with the clinical records. Further, the example work list presenter includes a record grouper to organize the clinical records using the classifications into a hierarchy associated with a multi-tiered structure for graphical display. Further, the example work list presenter includes a display generator to display one or more work items from the work list data in a first tier of the structure associated with the hierarchy, wherein the display generator is to display one or more nodes associated with a first one of the classifications in a second tier of the structure in response to a first selection of a first one of the work items, and wherein the display generator is to present one or more of the clinical records in the user interface in response to a second selection from a base tier of the structure.

### BRIEF DESCRIPTION OF THE DRAWINGS

FIG. 1 is a schematic illustration of an example clinical record system within which the example methods, apparatus, systems and articles of manufacture described herein may be implemented.

FIG. 2 is a block diagram of an example apparatus that may be used to implement the example work list presenter of FIG. 1.

FIG. 3 illustrates an example user interface that may be presented by the example work list presenter of FIGS. 1 and/or 2.

FIG. 4 is a flow diagram representative of example machine readable instructions that may be executed to implement the example work list presenter of FIGS. 1 and/or 2.

FIG. 5 illustrates another example user interface that may be presented by the example work list presenter of FIGS. 1 and/or 2.

FIG. 6 illustrates another example user interface that may be presented by the example work list presenter of FIGS. 1 and/or 2.

FIG. 7 is a block diagram of an example processor system that may be used to execute the machine readable instructions of FIG. 4 and/or to implement the example work list presenter of FIGS. 1 and/or 2.

### DETAILED DESCRIPTION

Although the following discloses example methods, apparatus, systems, and articles of manufacture including, among other components, firmware and/or software executed on hardware, it should be noted that such methods, apparatus, and systems are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Healthcare practitioners often work from fairly straightforward work lists of patients, exams, cases, etc. While some healthcare work lists may be sorted or re-ordered to, for example, place emergency cases at a top of a work list, many work lists are configured to facilitate a first come, first serve workflow. The information of such lists is normally listed in tables or spreadsheets and includes limited information, such as patient names, free text descriptions, and modality associated with an event or appointment. As a result, many current systems are not organized in a way to readily facilitate efficient medical evaluation, diagnosis, research and/or treatment. For example, parsing through lists of tables or spreadsheets of clinical records may fail to yield desired information and the additional time needed to gather the desired information may disrupt a physician's workflow. Moreover, practitioners are often required to access a plurality of information systems to obtain necessary materials or documentation due to the lack of context and detail provided by most work lists.

The example methods, apparatus, systems and/or articles of manufacture disclosed herein provide advantages over existing clinical record presentations. In particular, the example methods, apparatus, systems, and/or articles of manufacture described herein provide healthcare practitioners with user interfaces capable of conveying information and/or data related to medical histories of patients on a corresponding work list at a plurality of tiers or levels. That is, the elements of the example user interfaces described herein provide items of work lists that can be expanded, in an intuitive manner, to present organized information or data related to medical histories of the patients of the work lists. At a base tier or level, certain elements of the example user interfaces described herein can be selected to present specific images and corresponding findings associated with a certain test or procedure. In some examples, the types and amounts of aspects or portions of a medical history that can be conveyed by the example user interfaces described herein are limited only if a user chooses to limit the types and amounts of aspects or potions of the medical history to be presented with a work list.

To provide such capability, the example interfaces described herein and the supporting methods and apparatus organize aspects or portions of clinical records (e.g., of medical histories associated with patients) into groups according to sets of classifications or criteria. The groups are arranged into a hierarchy that forms a basis for the example user interfaces described herein. Generally, the hierarchy is presented to practitioners via the example interfaces described herein such that the practitioners can view different aspects or portions of a medical history of a patient at a plurality of tiers or levels of a tree structure. This presentation, which is described in greater detail below, can be manipulated by the practitioners to present different aspects or portions of the medical history in an efficient manner. For example, a first component of a first level of an example hierarchy can be expanded to display a second level of the example hierarchy if a practitioner wishes to obtain information related to the first component of the first level of the example hierarchy. Moreover, the practitioner can continue to expand elements of the hierarchy to additional tiers or levels until specific images and/or findings associated with a test or procedure are presented to the practitioner. Thus, on the same interface that acts as a work list for a practitioner, specific images and/or findings associated with tests and/or procedures corresponding to work list items may be presented to the practitioner. Such interfaces reduce time and resources expended to obtain information and data. Additional and alternative aspects and advantages of the examples described herein are described in greater detail below and will be evident therefrom.

In the interest of brevity and clarity, throughout the following disclosure references will be made to an example clinical records server 100. However, the methods, apparatus, systems and/or articles of manufacture described herein to group and present clinical records may be implemented by and/or within any number and/or type(s) of additional and/or alternative clinical records systems, servers and/or client devices. Such additional and/or alternative systems, servers and/or client devices may be communicatively coupled via any number and/or type(s) of public and/or private networks, and/or may be located and/or implemented at any number and/or type(s) of different geographically locations. Further, any of the methods, apparatus and articles of manufacture described herein could be implemented by or within a clinical records access terminal and/or client device that is communicatively coupled to the example clinical records server 100. Further still, presentations, screens and/or user interfaces generated by an example work list presenter 105, which is described in detail below, may be presented at the clinical records server 100 and/or at a clinic records access terminal and/or client device communicatively coupled to the server 100. Moreover, the example work list presenter 105 may be implemented at any number and/or type(s) of clinical records access terminals and/or client devices communicatively coupled to a clinical records server such as the example clinical records server 100.

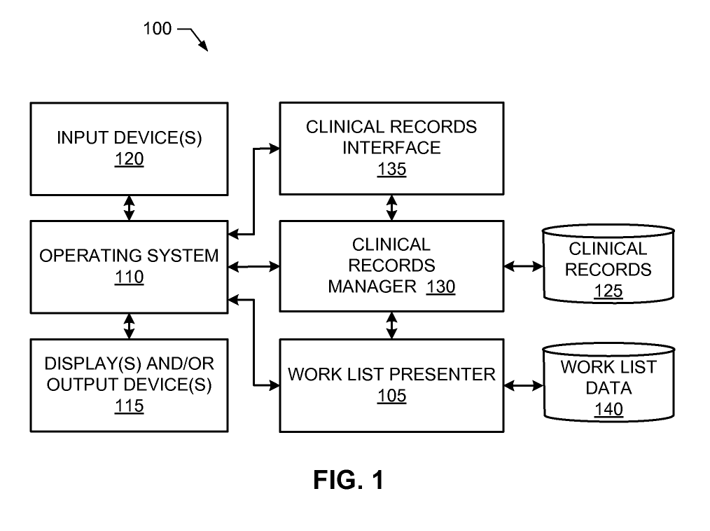

FIG. 1 illustrates the example clinical records server 100. To enable a user, such as a healthcare practitioner (e.g., a radiologists, a physician, s surgeon, a technician, an administrator, etc.) to interact with the example clinical records server 100, the clinical records server 100 of FIG. 1 includes an operating system 110, any number and/or type(s) of display(s) and/or output device(s) 115, and any number and/or type(s) of input device(s) 120. The example operating system 110 of FIG. 1 enables information (e.g., clinical records, medical records, test results, images, windows, screens, interfaces, dialog boxes, etc.) to be displayed at the display(s) and/or output device(s) 115, and to allow a user to control, configure and/or operate the example clinical records server 100 via the input device(s) 120. The user provides and/or makes inputs and/or selections via the input device(s) 120. Example input devices 120 include, but are not limited to, a keyboard, a touch screen, a trackball and/or a mouse, a microphone coupled to a voice recognition module, etc.

To manage patient and/or clinical records 125, the example clinical records server 100 of FIG. 1 includes a clinical records manager 130. The example clinical records manager 130 of FIG. 1 enables users via the operating system 110, the input device(s) 120, and/or the display(s) and/or output device(s) 115 to query and/or search for clinical records in the clinical records database 125. The example clinical records manager 130 also enables users via the operating system 110, the input device(s) 120, the display(s) and/or output device(s) 115 to add, create and/or modify clinical records in the database 125. In some examples, clinical records access terminals and/or client devices can access the clinical records database 125 via a clinical records interface or application programming interface 135 and the clinical records manager 130, and via any number and/or type(s) of private and/or public network(s). Patient and/or clinical records may be stored in the example clinical records database 125 using any number and/or type(s) of data structures, entries, tables and/or records. The example clinical records database 125 may be implemented by any number and/or type(s) of memory(-ies), memory device(s) and/or storage device(s).

The example clinical records database 125 may include and/or be in communication with additional record database(s) and may be capable of sharing data among the additional record database(s). For example, the example clinical records database 125 may be implemented as part of an Integrating the Healthcare Enterprise (IHE) Cross-Enterprise Document Sharing (XDS) integration profile, a health information exchange (HIE), a regional health information organization (RHIO), and/or any other system configured to facilitate sharing (e.g., registration, distribution, access, etc.) of healthcare data among the healthcare enterprises. Additionally or alternatively, the example clinical records database 125 may be implemented in a healthcare data system not having information sharing capabilities, such as a standalone physician office, a clinic or a hospital having a central data system.

To group and present clinical records according to the example methods and apparatus described herein, the example clinical record server 100 of FIG. 1 includes the example work list presenter 105. Generally, the example work list presenter 105 provides a user interface capable of presenting, for example, a work list to a practitioner. Data from which the work lists can be generated and/or the work lists themselves can be obtained from any suitable source. In the illustrated example, the data to be used by the work list presenter 105 to generate the user interface and the corresponding work lists is obtained from a work list database 140. The example work list database 140 can be populated by, for example, a practitioner, one or more members of a staff, administrators, an automated system or device, etc. The example work list database 140 can include one or more work lists for each practitioner as identified by, for example, a unique identifier associated with each practitioner. An example work list can include a plurality of patients identified by, for example, a plurality of corresponding unique identifiers. Each patient of a work list may be associated with one or more work items or tasks.

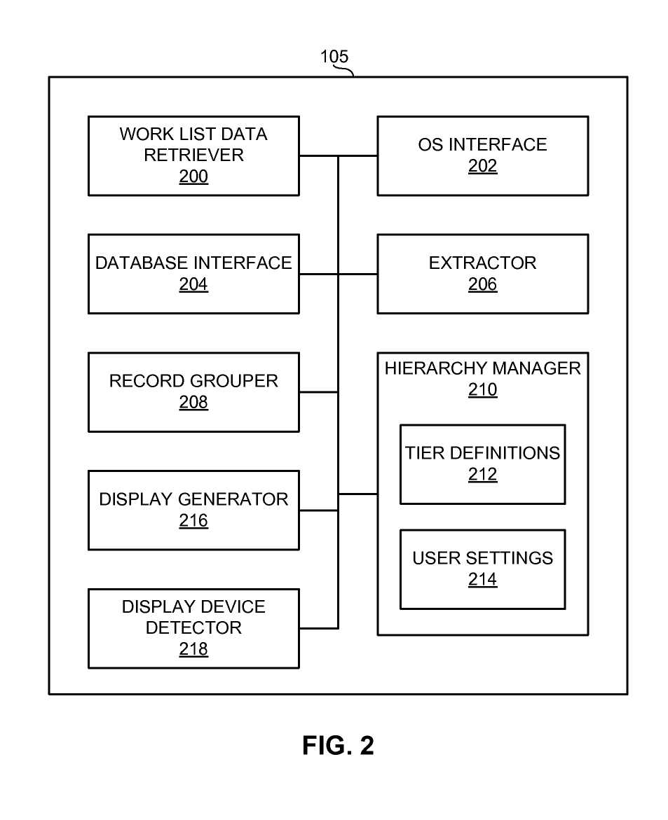

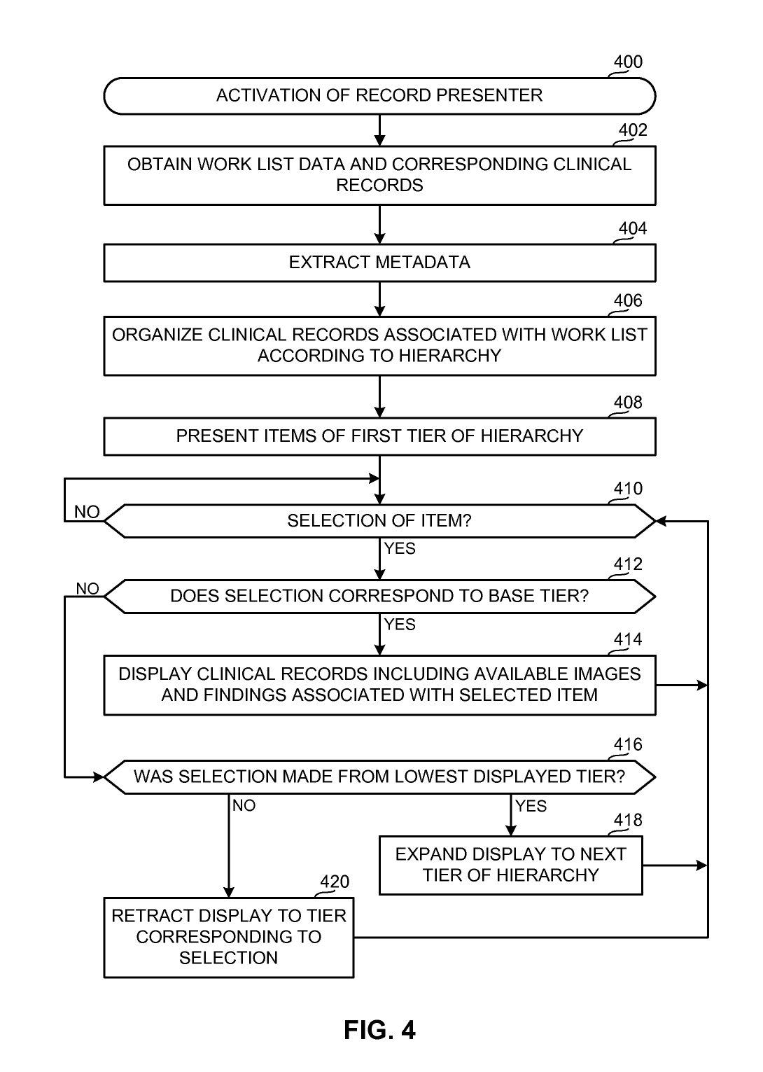

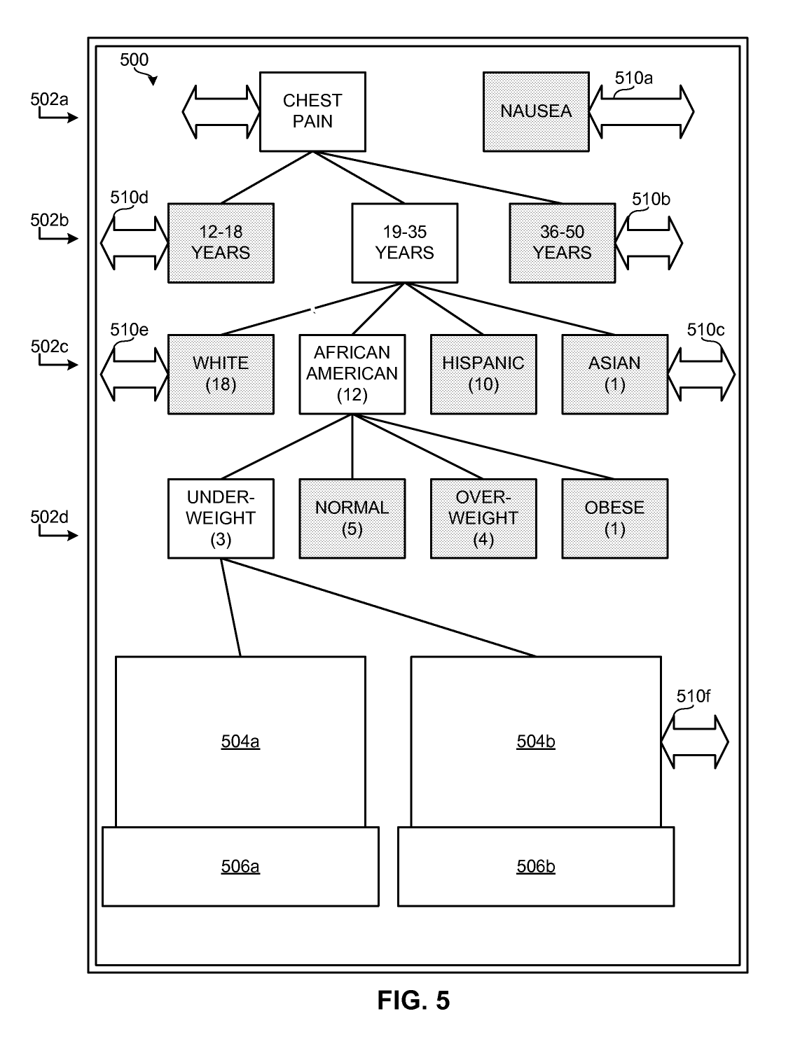

FIG. 2 is a block diagram of an example apparatus that may be used to implement the example work list presenter 105 of FIG. 1. Generally, the example work list presenter 105 of FIG. 2 obtains data associated with the work lists of the work list database 140 and organizes the data in an example user interface (e.g., the user interface 400 of FIG. 4 or the user interface 500 of FIG. 5) to a healthcare practitioner. The example user interface enables the practitioner to readily and intuitively navigate through contents of the work list. Additionally, the user interface responds to inputs from the practitioner and provides clinical images and/or findings associated with items or patients from the work list. Thus, in addition to items of work scheduled for the practitioner, the example user interface described herein presents the practitioner with clinical data related to each work item including, for example, images and findings from a medical history of a patient associated with a work item. As described above, such a user interface improves the ability of the practitioner to obtain necessary information from a single user interface without having to access multiple sources of information. As will be evident by the following description and the corresponding figures, the example user interface described herein may be particularly useful to a practitioner using a handheld device such as, for example, a smart phone or an electronic tablet being used during a medical procedure.

To obtain data associated with a work list to be used to generate a user interface for a practitioner, the example work list presenter 105 includes a work list data retriever 200. The example work list data retriever 200 of FIG. 2 accesses the work list database 140 of FIG. 1 in response to, for example, an activation of the example work list presenter 105 by a practitioner or engagement of a refresh or load option on the user interface. The activation or refresh may be accompanied by an identifier corresponding to the activating practitioner. The example work list data retriever 200 uses the practitioner identifier as a query to the work list database 140. In turn, the example work list data retriever 200 receives data associated with a work list for the practitioner. The received data may include, for example, a list of unique identifiers corresponding to a list of patients to be seen by the practitioner according to the work list along with scheduling information associated with each patient. Thus, the work list data retriever 200 is capable of obtaining a list of patients for which the practitioner needs to prepare, evaluate and/or diagnose.

As described above, previous systems present simple lists of information to practitioners including patient names, modalities and, perhaps, a textual description. In contrast, the user interface provided by the example work list presenter 105 of FIGS. 1 and 2 can present the practitioner with clinical records and associated findings associated with work list items in an organized manner that facilitates efficient navigation thereof. To obtain the clinical records associated with work list items, the example work list presenter 105 includes an operating system interface 202 and a database interface 204. The example operating system interface 202 and/or the database interface 204 can obtain contents of the clinical records database 125 of FIG. 1 by, for example, using the patient identifiers received with the work list data as an aspect of a query into the clinical records database 125. In some examples, the example operating system interface 202 obtains clinical records from and/or via the operating system 110. Additionally or alternatively, the example operating system 110 may provide identifier(s) of the selected records to the work list presenter 105 via the example operating interface 202 and the example database interface 204 may obtain the records by querying the example clinical records database 125 via the example clinical records manager 130. The example operating interface 202 and the example database interface 204 are capable of conveying and receiving additional or alternative types of data, instructions, and/or any other suitable information to and from additional or alternative sources.

The example work list presenter 105 receives the clinical records associated with work list items (e.g., via the operating system interface 202 or the database interface 204) and extracts information therefrom using an extractor 206. In particular, the example extractor 206 of FIG. 2 analyzes the clinical records received from the clinical records database 125 to identify one or more classifications or categorizations associated with each clinical record. For example, the extractor 206 may identify and extract metadata from the clinical records that acts as a label or descriptor of the contents of the clinical records. Many clinical records are stored according to one or more standards such as, for example, the Digital Imaging and Communications in Medicine (DICOM) standard. The DICOM standard provides a set of tags that are ascribed to clinical records to indicate what type(s) of information or data are included therein. The example extractor 206 is capable of identifying and interpreting DICOM tags and/or any other type of metadata indicative of the contents of clinical records. For example, the extractor 206 may identify a first clinical record associated with a first patient in a work list as being (1) an x-ray image (2) of a wrist (3) that resulted in a diagnosis of a fracture in a metacarpal. The example extractor 206 may also identify a second clinical record associated with the first patient as being (1) an MRI scan (2) of a spleen (3) that resulted in a diagnosis of a third degree laceration of the spleen. The example extractor 206 may also identify a third clinical record associated with a second patient as being (1) a CT scan (2) of a brain (3) that resulted in a diagnosis of a hemorrhage. The example extractor 206 may identify and extract different types and/or amounts of data at different levels of granularity as determined by, for example, user-selected options, default settings, etc.

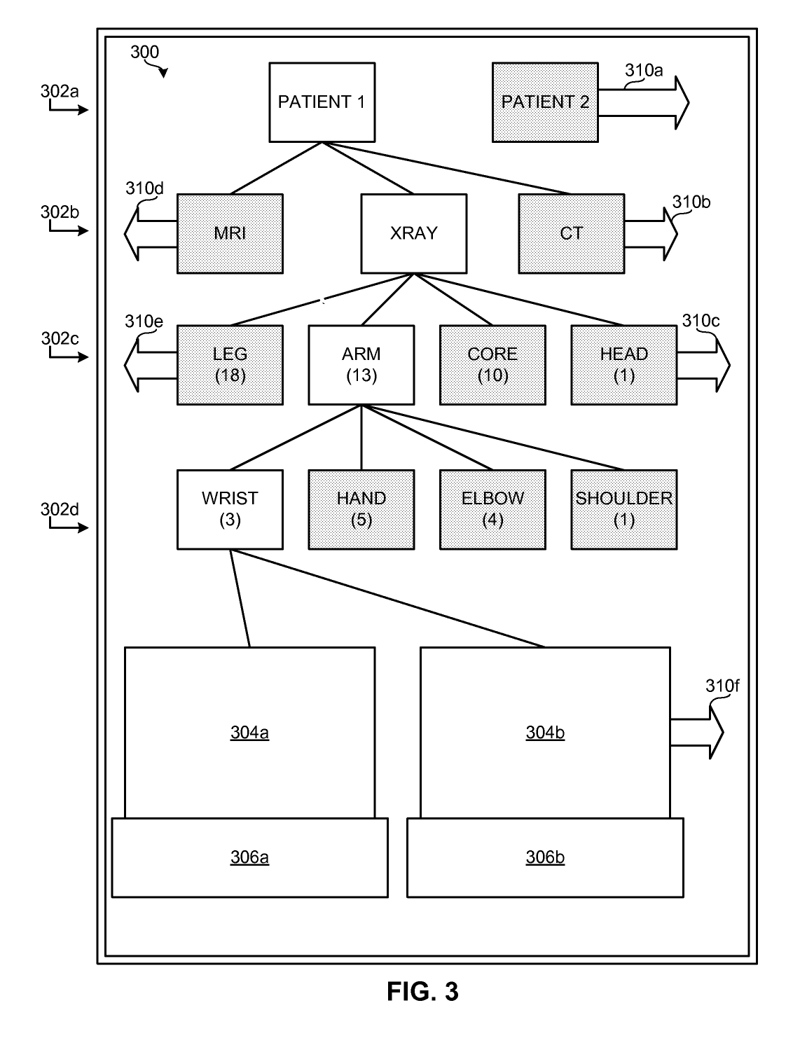

To organize the clinical records retrieved from the clinical records database 125 for the example user interface, the example work list presenter 105 of FIG. 2 includes a record grouper 208. The example record grouper 208 of FIG. 2 uses the information extracted by the example extractor 206 to organize the clinical records into a tree structure to be displayed as the example user interface described herein. An example implementation of such a user interface 300 is shown in FIG. 3. The example user interface 300 of FIG. 3 includes a plurality of tiers 302 each having a plurality of elements. In the illustrated example of FIG. 3, a first tier 302a includes the patients of the retrieved work list; a second tier 302b includes a plurality of exam types associated with the clinical records associated with the work list; a third tier 302c includes a plurality of body regions associated with the clinical records associated with the work list; and a fourth tier 302d includes a plurality of body parts associated with the clinical records associated with the work list. Each of the tiers 302 has a plurality of nodes, as shown in FIG. 3.

Therefore, when the example work list presenter 105 of FIG. 2 is implementing the example user interface 300 of FIG. 3, the example record grouper 208 uses the information extracted by the extractor 206 to first group clinical records according to an exam type, body region, and body part. To do so, the example record grouper 208 may tag each clinical record with a group identifier to indicate to which node the clinical record belongs and from which node(s) the clinical record should extend. As a result, as shown in the example user interface 300 of FIG. 3, a first node of the third tier 302c (labeled as a ‘LEG’ node) extends from a first node of the second tier 302b (labeled as an ‘X-RAY’ node) and includes eighteen clinical records; a second node of the third tier 302c (labeled as an ‘ARM’ node) extends from the ‘X-RAY’ node) and includes thirteen clinical records; etc. Further, as shown in the example user interface 300 of FIG. 3, a first node of the fourth tier 302d (labeled as a ‘WRIST’ node) extends from the ‘ARM’ node and includes three clinical records; a second node of the fourth tier 302d (labeled as a ‘HAND’ node) extends from the ‘ARM’ node and includes five clinical records; etc.

While an example user interface 300 is shown in FIG. 3, alternative and/or additional elements, arrangements, etc. can be implemented by the example work list presenter 105. To control to arrangement, content, and/or other aspects of the tree structure to be displayed in the example user interfaces described herein, the example work list presenter 105 includes a hierarchy manager 210. Generally, the example hierarchy manager 210 manages and includes data indicative of the manner in which the tree structured user interfaces described herein are assembled, presented, and organized. The example hierarchy manager 210 of FIG. 2 includes tier definitions 212 and user settings 214. The tier definitions 212 determine a number of tiers to be included in the tree structure, an order of the tiers, and a structure of edges between nodes. For example, the third tier 302c of FIG. 3 includes body regions and extends from a node of the second tier 302b because of a configuration of a corresponding one of the tier definitions 212.

The user settings 214 store entries for a plurality of practitioners. For a practitioner using the example work list presenter 105, a temporary entry initially set to default values may be stored in the user settings 214. A temporary identifier may be assigned to such a temporary user. Additionally, the user settings 214 include entries for repeat users of the work list presenter 105 that may be required to register to receive identifiers that are used to maintain the corresponding settings. The user settings 214, which can implement a dedicated user interface to enable practitioners to alter the corresponding entries, determine a plurality of aspects of the example user interfaces described herein. For example, the user settings 214 may affect the tier definitions 212 and, therefore, the overall organization of the tree structure of the example user interface 300 of FIG. 3. As a result, practitioners can control an arrangement of the nodes of the user interface 300. In some example, the user settings 214 present practitioners with one or more themes or preset arrangements from which the practitioners may choose. The user settings 214 also enable the practitioners to create a customized arrangement of the user interface 300. Additionally or alternatively, the user settings 214 may include one or more shared settings through which practitioners can provide customized arrangements available to other practitioners via an input (e.g., engagement of an element of the user interface 300 of FIG. 3 or via any other suitable input, such as a voice recognition module capable of taking dictation).

When the example record grouper 208 has cooperated with the hierarchy manager 210 to create a tree structure for the example user interfaces described herein, the example work list presenter 105 uses a display generator 216 to generate a display of the user interface. The example display generator 218 utilizes a display device detector 218 to determine a type of device on which the user interface is to be displayed. The example display generator 216 may customize the user interface in one or more manners based on which type of device is to display the user interface. For example, when the display device detector 218 determines that a handheld device is using the work list presenter 105 to display the user interface, the example display generator 216 may choose a designated version of the user interface or may add or alter data to the user interface data to customize the user interface for smaller display screens and/or screens utilizing a touch screen. In some examples, the user interface may be conveyed to the device utilizing the work list presenter 105 without regard to the type of the device. In such instances, the device may be capable of customizing the user interface for the display thereof.

Additionally, the display generator 216 configures the example user interfaces described herein to display certain portions of the tree structure at certain times and in response to certain inputs. For example, with reference to the example user interface 300 of FIG. 3, the display generator 216 may cause only the first tier 302a to be displayed in response to an activation of the user interface 300. Further, the example display generator 216 of FIG. 2 may assign one or more edges to each node of the structures according to the tier definitions 212. As a result, in response to a selection of one of the nodes of the first tier 302a, the nodes of the second tier 302b and the assigned edges are displayed. As the user progresses through the tiers 302, the nodes and the edges assigned thereto are displayed to reveal the tree structure defined by the hierarchy manager 210.

The example display generator 216 also generates presentations of the clinical records retrieved from the example clinical records database 125 of FIG. 1. As shown in the example user interface 300 of FIG. 3, when a user has filtered down the tree structure to a base tier (e.g., the fourth tier 302d in FIG. 3) at which clinical records are available, the practitioner is presented with, for example, an image 304 and the corresponding findings or diagnoses 306 associated with one or more clinical records. The example display generator 216 determines a manner in which the image 304 and findings 306 are presented to the practitioner. For example, the display generator 216 may cause the image 304 to be enlarged to a full screen mode in response to a selection of the image 304 via any suitable input. Additional aspects of the presentation of the user interface and other interactions that a practitioner may have with the user interface are described below in connection with FIGS. 3 and 4.

While an example manner of implementing the report presenter 105 of FIG. 1 has been illustrated in FIG. 2, one or more of the elements, processes and/or devices illustrated in FIG. 2 may be combined, divided, re-arranged, omitted, eliminated and/or implemented in any other way. Further, the example work list retriever 200, the example operating system interface 202, the example database interface 204, the example extractor 206, the example record grouper 208, the example hierarchy manager 210 including the example tier definitions 212 and the user settings 214, the example display generator 216, the example display device detector 218, and/or, more generally, the example report presenter 105 of FIG. 2 may be implemented by hardware, software, firmware and/or any combination of hardware, software and/or firmware. Thus, for example, any of the example work list retriever 200, the example operating system interface 202, the example database interface 204, the example extractor 206, the example record grouper 208, the example hierarchy manager 210 including the example tier definitions 212 and the user settings 214, the example display generator 216, the example display device detector 218, and/or, more generally, the example report presenter 105 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example work list retriever 200, the example operating system interface 202, the example database interface 204, the example extractor 206, the example record grouper 208, the example hierarchy manager 210 including the example tier definitions 212 and the user settings 214, the example display generator 216, the example display device detector 218, and/or, more generally, the example report presenter 105 of FIG. 2 are hereby expressly defined to include a tangible medium such as a memory, DVD, CD, etc., storing the software and/or firmware. Further still, the example report presenter 105 of FIG. 2 may include one or more elements, processes and/or devices in addition to, or instead of, those illustrated in FIG. 2, and/or may include more than one of any or all of the illustrated elements, processes and devices.

As described above, FIG. 3 illustrates an example user interface 300 implemented by the example work list presenter 105 of FIGS. 1 and/or 2. When the example work list presenter 105 is activated or called, the nodes of the first tier 302a are displayed in the user interface 300. The nodes of the first tier 302a correspond to patients of a work list. The nodes may be arranged from left to right according to schedule information related to the work list. For example, a node 308 labeled as ‘PATIENT l’ in the first tier corresponds to a first items of the work list (e.g., the next scheduled work item, such as an emergency that has been placed on the top of the work list). The term ‘PATIENT l’ may be replaced by an actual name of the corresponding patient.

When more work list items than are currently displayed are available, the rightmost node of the first tier 302a includes a scroll arrow 310a. The practitioner may engage the scroll arrow 310a to parse through the work list by patient names or items. That is, the nodes of the first tier 302a are shifted to display other nodes corresponding to other patients. The example user interface 300 includes additional scroll arrows 310b-f that operate similarly to the scroll arrow 310a of the first tier 302a. Engagement of one of the scroll arrows 310b-f may shift elements of a corresponding one of the tiers 302 without affecting the other tiers.

In response to the practitioner selecting one of the nodes of the first tier 302a, the next tier is displayed to the practitioner along with the corresponding edges. A selection may be made via any suitable input such as, for example, an engagement of a corresponding portion of a touch screen, a voice command, a selection using a cursor controlled by a mouse, etc. In the illustrated example of FIG. 3, the practitioner has selected the node labeled ‘PATIENT l’ and, therefore, the second tier 302b comprises indications of clinical records associated with the first patient of the work list. As the tier definitions 212 of FIG. 2 define the second tier 302b to include types of exams, the second tier 302b of the example user interface 300 of FIG. 3 includes a node for MRI scans, a node for x-rays and a node for CT scans. As indicated by the scroll arrows 310b and 310d, additional types of exams are available for the first patient. Accordingly, the first patient has undergone each of these types of scans or tests, which were documented in the clinical records database 125.

In response to the practitioner selecting one of the nodes of the second tier 302b, the next tier is displayed to the practitioner along with the corresponding edges. In the illustrated example of FIG. 3, the practitioner has selected the node labeled ‘X-RAY’ and, therefore, the third tier 302c comprises indications of clinical records associated with x-ray images taken of the first patient of the work list. As the tier definitions 212 of FIG. 2 define the third tier 302c to include body regions, the third tier 302c of the example user interface 300 of FIG. 3 includes a node for legs, a node for arms, a node for a core, and a node for a head. As indicated by the scroll arrows 310c and 310e, additional body regions are available for the first patient. Accordingly, the first patient has undergone x-ray imaging on each of these body regions, which were documented in the clinical records database 125.

In response to the practitioner selecting one of the nodes of the third tier 302c, the next tier is displayed to the practitioner along with the corresponding edges. In the illustrated example of FIG. 3, the practitioner has selected the node labeled ‘ARM’ and, therefore, the fourth tier 302d comprises indications of clinical records associated with x-ray images taken of the arm of the first patient of the work list. As the tier definitions 212 of FIG. 2 define the fourth tier 302d to include body parts, the fourth tier 302d of the example user interface 300 of FIG. 3 includes a node for wrists, a node hands, a node elbows, and a node for shoulders. As indicated by the lack of scroll arrows on the fourth tier 302d, no additional body parts are available for the first patient. Accordingly, the first patient has undergone x-ray imaging on the body parts indicated in the fourth tier 302d, which were documented in the clinical records database 125.

In the illustrated example of FIG. 3, the fourth tier 302d is a base tier in that at least one node of the fourth tier 302d can be selected to cause a presentation of one or more clinical records. As shown in FIG. 3, the practitioner has selected the node of the fourth tier 302 labeled as the ‘WRIST’ node, which has three clinical records associated therewith. In other words, the first patient has undergone three wrist x-rays that can be viewed be selecting the appropriate node. In the illustrated example, a first image 304a associated with a first x-ray, along with a first set of findings 306a, is presented in the user interface 300 in response to a selection of the ‘WRIST’ node. Further, a second image 304b associated with a second x-ray, along with a second set of findings 306b, is presented in the user interface 300 in response to a selection of the ‘WRIST’ node.

In some examples, when the practitioner is previously aware of the selections he or she desires to make from the tree structure, the practitioner may navigate to the base tier (or any previous tier) by selecting a dictation option or button and speaking the selections. For example, the practitioner may speak the following phrase into the device to navigate to the base tier 302d as shown in FIG. 3: “Patient1/X-ray/Arm/Wrist.” Such a feature may be used when the practitioner wishes to return to a recently visited image or finding belonging to the ‘WRIST’ element of the base tier 302d.

As indicated by the scroll arrow 310f, another image associated with a third x-ray, along with a third set of findings, may be presented in response to a selection of the scroll arrow 310f. In some examples, the first or second images 304a-b and/or the first and second sets of findings 306a-b may be selected to enlarge the respective selection. In such instances, the images 304a-b or the findings 306a-b may be enlarged to overlap with one or more other elements of the user interface 300 and/or take up the entire screen. Additionally or alternatively, the example images 304a-b and/or the sets of findings 306a-b may be selected to present a list of options to the practitioner. Example options include the ability to electronically send the corresponding selection (e.g., via email) to a designated destination, to print the corresponding selection, to obtain additional information regarding the corresponding clinical record (e.g., bibliographic information associated with the patient), etc.

When the example user interface 300 has at least one tier expanded from the first tier 302a (e.g., when at least a patient node has been selected), other nodes of the first tier 302a may be selected. In the illustrated example, such selections cause a presentation of information related to the newly selected work item or patient at the same tier that was expanded before the selection of the new work item or patient.

The example user interface 300 shows how a practitioner using the user interface 300 as a work list may easily navigate through a work list and readily obtain information related to items of the work list. When the first patient node is selected and the second tier 302b is expanded onto the user interface 300, the practitioner can immediately realize that the first patient has had undergone a significant number of tests and/or procedures. With further investigation into the tree structure (e.g., by displaying the third tier 302c), the practitioner can also immediately realize that the first patient has undergone tests and/or procedures related to a significant number of body regions. Moreover, the practitioner can drill into the tree structure down to the base tier obtain specific information and copies of clinical records and findings. Therefore, the example user interface 300 of FIG. 3 provides the practitioner with a useful work list and, on the same user interface, access to clinical documentation that can used to perform the items of the work list.

FIG. 4 is a flow diagram representative of example machine readable instructions that may be executed to implement the example work list presenter 105 of FIGS. 1 and/or 2 group and present clinical records. The example processes of FIG. 4 may be performed using a processor, a controller and/or any other suitable processing device. For example, the example processes of FIG. 4 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 4 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 4 may be implemented manually or as any combination(s) of any of the foregoing techniques, for example, any combination of firmware, software, discrete logic and/or hardware. Further, although the example processes of FIG. 4 are described with reference to the flow diagrams of FIG. 4, other methods of implementing the processes of FIG. 4 may be employed. For example, the order of execution of the blocks may be changed, and/or some of the blocks described may be changed, eliminated, sub-divided, or combined. Additionally, any or all of the example processes of FIG. 4 may be performed sequentially and/or in parallel by, for example, separate processing threads, processors, devices, discrete logic, circuits, etc.

The example flow diagram of FIG. 4 begins with an activation of the work list presenter 105 (block 400). For example, a practitioner may start an application or program associated with the record presenter 105. To provide the practitioner with access to the work list presenter 105 and the corresponding user interfaces, the practitioner provides identification such as a login and/or a password. The example work list data retriever 200 (FIG. 2) uses the identification to obtain work list data associated with the identified practitioner from the work list database 140 (FIG. 1). Further, patient identifiers received with the work list data are used to query the clinical records database 125 (FIG. 1) (block 402). The obtained work list data includes one or more work items corresponding to one or more patients on a schedule of the practitioner. The clinical records obtained from the clinical records database 125 include metadata indicative of classification or types of the clinical records. The example extractor 206 (FIG. 2) identifies and extracts this metadata (block 404). The extracted metadata is used to organize the clinical records according to a hierarchy. In particular, the example record grouper 208 (FIG. 2) references the tier definitions 212 (FIG. 2) of the example hierarchy manager 210 (FIG. 2) and/or the user settings 214 of the example hierarchy manager 210. The example record grouper 208 organizes the clinical records using the metadata and the hierarchy manager 210 (block 406).

The example display generator 216 (FIG. 2) then presents the first tier of the tree structure of the example user interfaces described herein (block 408). The first tier of the tree structure includes one or more nodes corresponding to a work item or a patient. With reference to the example user interface 300 of FIG. 3, the first tier 302a includes at nodes labeled with patient names. The nodes of the first tier can be parsed using a scroll arrow to shift the displayed nodes of the first tier. To obtain additional information regarding a work item, a practitioner may select one of the nodes of the first tier (block 410). If such a selection corresponds to a base tier (block 412), which in the instance of the selection being from the first tier is not likely, the display generator 216 causes the corresponding clinical images and any findings associated therewith to be presented to the practitioner (block 414). Otherwise, if the selection does not correspond to a base tier (block 412) and the selection was made from a lowest currently displayed tier (block 416), the user interface is expanded to the next tier according to the hierarchy manager 210 (block 418). If the selection does not correspond to a base tier (block 412) and the selection was not made from the lowest currently displayed tier (block 416), the user interface is retracted to the tier corresponding to the selection (block 420). Therefore, the user interfaces described herein can be expanding and retracted according to selections made thereon.

FIG. 5 illustrates another example user interface 500 that may be presented by the example work list presenter 105 of FIGS. 1 and/or 2. In the illustrated example of FIG. 5, the work list presenter 105 operates in a different mode to present a user, such as a healthcare practitioner or a person performing research, for example. Generally, the example user interface 500 of FIG. 5 operates similarly to the example user interface 300 of FIG. 3. Nodes of a plurality of tiers 502 can be selected to expand to a next one of the tiers based on a type of information desired by the user. Further, selection of a node at a base tier (e.g., the fourth tier 502d in FIG. 5) causes a presentation of specific clinical images and/or findings associated with a test or study grouped into the selected node.

However, the tiers 502 of the example user interface 500 of FIG. 5 and the nodes thereof represent different types of grouping than the tiers 302 of the example user interface 300 of FIG. 3. In particular, the classifications used to generate the example user interface 500 of FIG. 5, which may be obtained by the example operating system interface 202 or the database interface 204 of the example work list presenter 105, are demographic and/or psychographic classifications, for example. As shown in FIG. 5, the first tier 502 of the example user interface 500 includes primary symptoms, which can be extracted by the example extractor 206 via metadata, listed for a given study or case. Selection of one of the symptom nodes causes an expansion of the user interface 500 to the second tier 502b, which includes age ranges extracted by the example extractor 206, for example. Selection of one of the age nodes causes an expansion of the user interface 500 to the third tier 502c, which includes ethnicity information extracted by the example extractor 206, for example. Selection of one of the ethnicity nodes causes an expansion of the user interface 500 to the fourth tier 502d, which includes weight conditions extracted by the example extractor 206, for example.

In the illustrated example, the fourth tier 502d is a base tier in that selection of a node thereof causes the display generator 216 to present the user with one or more clinical images 504 and/or findings 506 associated with tests, procedures, or studies corresponding to the filtered criteria made by the selections described above. As shown in FIG. 5, the user has selected an under-weight African American between the ages of nineteen and thirty-five years old that presented chest pain. Additional or alternative types of classifications, criteria or filters can be used in the hierarchy manager 210 for the tier definitions 212 that dictate aspects of the tree structure for the user interface 500 of FIG. 5.

A practitioner may cause the example work list presenter 105 to operate in the mode corresponding to the example user interface 500 of FIG. 5 when, for example, diagnosing a patient and similar cases are sought for purposes of comparison. For example, a practitioner having a forty year old, white, obese patient reporting nausea may want to compare the observed condition of the patient with similar cases to gain an understanding of possible causes, other symptoms, potential long term effects, etc. The example user interface 500 of FIG. 5 enables such a practitioner to efficiently access such information without having to access multiple systems or resources and to do so in an intuitive manner using the tree structure thereof.

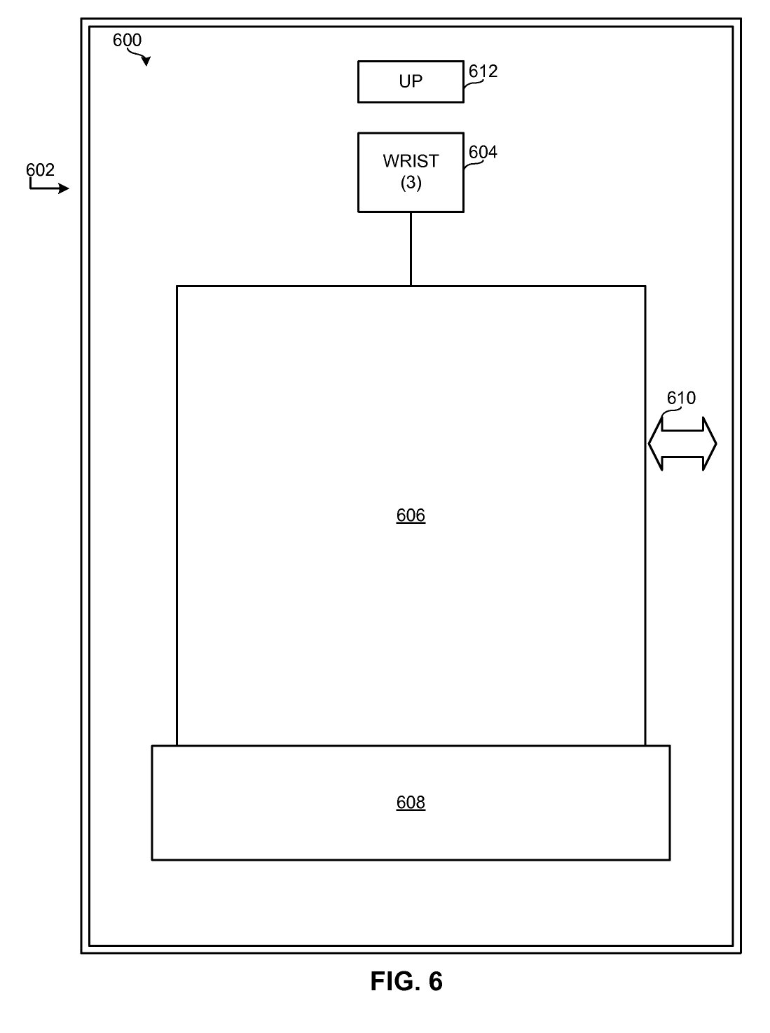

FIG. 6 illustrates a portion of another example user interface 600 that may be presented by the example work list presenter of FIGS. 1 and/or 2. The example user interface 600 of FIG. 6 operates in a similar manner as the example user interfaces 300 and 500 of FIGS. 3 and 5, respectively, at the initial stages of display. For example, a first tier (not shown) corresponding to a plurality of work items or patients may be displayed initially. Further, a selection from the first tier may cause a second tier (not shown) to expand from the first tier. In some examples of the user interface 600 of FIG. 6, the first tier may be removed from the display or shrunk after a selection is made therefrom and the second tier may occupy the position previously occupied by the first tier. This process may continue as described above until a base tier 602 is shown.

In the illustrated example of FIG. 6, selection of one of the items 604 of the base tier 602 causes a removal (as shown in FIG. 6) or shrinking (not shown) of the tiers positioned above the base tier 602 from the display. Additionally, in the example user interface 600 of FIG. 6, a display of at least a first one of the images 606 and findings 608 is expanded to occupy at least some portion of the display previously occupied by the upper tiers of the tree structure. The example user interface 600 includes a scroll arrow 610 such that the practitioner can scroll between images and findings in the expanded state. To enable the user to return to the previous tiers farther up the tree structure, the example user interface 600 includes an ‘UP’ button 612 that causes the previous tiers to be displayed and, in some examples, the image 606 and findings 608 to return to the initial size (e.g., the size shown in the example user interfaces 300 and 500 of FIGS. 3 and 5).

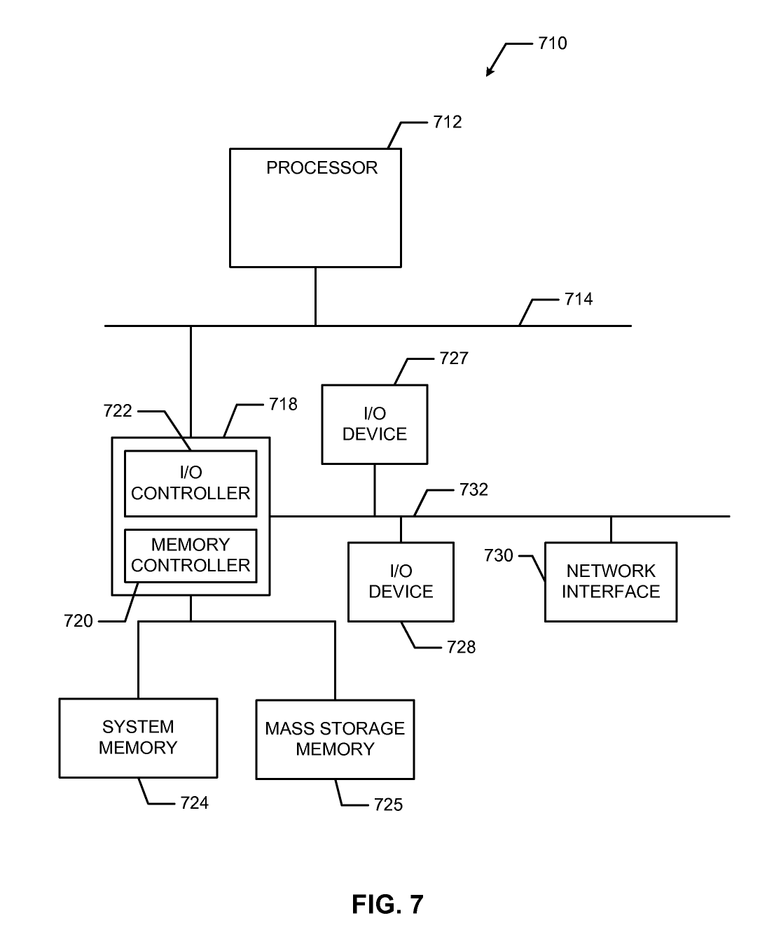

FIG. 7 is a block diagram of an example processor system 710 that may be used to implement the apparatus and methods described herein. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer-implemented method of grouping and presenting clinical records in a user interface, the method comprising:
obtaining work list data of a healthcare practitioner and one or more clinical records associated with the work list data;
extracting descriptive information from the clinical records to obtain one or more classifications associated with the clinical records;
organizing the clinical records using the classifications into a hierarchy associated with a multi-tiered structure for graphical display;
displaying one or more work items from the work list data in a first tier of the structure associated with the hierarchy;
displaying one or more nodes associated with a first one of the classifications in a second tier of the structure in response to a first selection of a first one of the work items; and
presenting one or more of the clinical records in the user interface in response to a second selection from a base tier of the structure.

2. A method as defined in claim 1, wherein obtaining the work list data associated with the healthcare practitioner comprises using an identifier associated with the healthcare practitioner to query a database including work lists associated with a plurality of healthcare practitioners.

3. A method as defined in claim 1, wherein presenting the one or more clinical records in the user interface comprises displaying at least one image of a respective clinical record on the user interface.

4. A method as defined in claim 3, wherein presenting the one or more clinical records in the user interface comprises displaying findings associated with the at least one image.

5. A method as defined in claim 1, further comprising enabling the healthcare practitioner to select a number of tiers for the structure and which classifications are used for each of the tiers.

6. A method as defined in claim 1, further comprising detecting a type of output device on which the user interface is to be displayed and customizing the user interface to for the detected type of output device.

7. A method as defined in claim 1, wherein the structure is arranged as a tree structure having the second tier expanding from the selected work item of the first tier.

8. An tangible computer readable medium having instructions stored thereon that, when executed cause a machine to:
obtain work list data of a healthcare practitioner and one or more clinical records associated with the work list data;
extract descriptive information from the clinical records to obtain one or more classifications associated with the clinical records;
organize the clinical records using the classifications into a hierarchy associated with a multi-tiered structure for graphical display;
display one or more work items from the work list data in a first tier of the structure associated with the hierarchy;
display one or more nodes associated with a first one of the classifications in a second tier of the structure in response to a first selection of a first one of the work items; and
present one or more of the clinical records in the user interface in response to a second selection from a base tier of the structure.

9. A tangible machine readable medium as defined in claim 9 having instructions stored thereon that, when executed, cause a machine to obtain the work list data associated with the healthcare practitioner by using an identifier associated with the healthcare practitioner to query a database including work lists associated with a plurality of healthcare practitioners.

10. A tangible machine readable medium as defined in claim 9 having instructions stored thereon that, when executed, cause a machine to present the one or more clinical records in the user interface comprises displaying at least one image of a respective clinical record on the user interface.

11. A tangible machine readable medium as defined in claim 10 having instructions stored thereon that, when executed, cause a machine to present the one or more clinical records in the user interface comprises displaying findings associated with the at least one image.

12. A tangible machine readable medium as defined in claim 9 having instructions stored thereon that, when executed, cause a machine to enable the healthcare practitioner to select a number of tiers for the structure and which classifications are used for each of the tiers.

13. A tangible machine readable medium as defined in claim 9 having instructions stored thereon that, when executed, cause a machine to detect a type of output device on which the user interface is to be displayed and to customize the user interface to for the detected type of output device.

14. A tangible machine readable medium as defined in claim 9, wherein the structure is arranged as a tree structure having the second tier expanding from the selected work item of the first tier.

15. A work list presenter to group and present clinical records in a user interface, the work list presenter comprising:
a retriever to obtain work list data of a healthcare practitioner;
one or more interfaces to obtain one or more clinical records associated with the work list data;
an extractor to extract descriptive information from the clinical records to obtain one or more classifications associated with the clinical records;
a record grouper to organize the clinical records using the classifications into a hierarchy associated with a multi-tiered structure for graphical display;
a display generator to display one or more work items from the work list data in a first tier of the structure associated with the hierarchy, wherein the display generator is to display one or more nodes associated with a first one of the classifications in a second tier of the structure in response to a first selection of a first one of the work items, and wherein the display generator is to present one or more of the clinical records in the user interface in response to a second selection from a base tier of the structure.

16. A work list presenter as defined in claim 15, wherein the retriever is to obtain the work list data associated with the healthcare practitioner by using an identifier associated with the healthcare practitioner to query a database including work lists associated with a plurality of healthcare practitioners.

17. A work list presenter as defined in claim 15, wherein the display generator is to present the one or more clinical records in the user interface comprises displaying at least one image of a respective clinical record on the user interface.

18. A work list presenter as defined in claim 17, wherein the display generator is to present the one or more clinical records in the user interface by displaying findings associated with the at least one image.

19. A work list presenter as defined in claim 15, further comprising user setting to enable the healthcare practitioner to select a number of tiers for the structure and which classifications are used for each of the tiers.

20. A work list presenter as defined in claim 15, further comprising a detector to detect a type of output device on which the user interface is to be displayed, and wherein the display generator is to customize the user interface to for the detected type of output device.

21. A work list presenter as defined in claim 15, wherein the structure is arranged as a tree structure having the second tier expanding from the selected work item of the first tier.
